(19) United States
(12) Patent Application Publication
(10) Pub. No.: US 2024/0177018 A1
(43) Pub. Date: May 30, 2024

(54) Systems and Methods for Differentially Private Federated Machine Learning for Large Models and a Strong Adversary

(71) Applicant: The Regents of the University of California, Oakland, CA (US)

(72) Inventors: Trinabh Gupta, Goleta, CA (US); Kunlong Liu, Santa Barbara, CA (US); Richa Wadaskar, Santa Barbara, CA (US)

(73) Assignee: The Regents of the University of California, Oakland, CA (US)

(21) Appl. No.: 18/493,571

(22) Filed: Oct. 24, 2023

Related U.S. Application Data
(60) Provisional application No. 63/380,743, filed on Oct. 24, 2022.

(51) Int. Cl. G06N 3/098; H04L 9/08

(52) U.S. Cl. CPC G06N 3/098; H04L 9/08

(57) ABSTRACT

Systems and methods for federated learning are illustrated. A method for federated learning includes steps for identifying a first set of one or more devices as members of a master committee, identifying a second set of one or more devices as members of a differential privacy (DP)-noise committee, receiving a set of encrypted noise values for differential privacy from the members of the DP-noise committee, receiving, from a third set of one or more devices, a set of encrypted update values, and aggregating the encrypted noise values and the encrypted update values to produce encrypted aggregation results. The method further includes steps for receiving, from a fourth set of one or more devices, decrypted aggregation results based on cryptographic key shares of a private cryptographic key from the master committee, and updating model parameters of the model based on the decrypted aggregation results.

### CROSS-REFERENCE TO RELATED APPLICATIONS

The current application claims the benefit of and priority under 35 U.S.C. § 119(e) to U.S. Provisional Patent Application No. 63/380,743 entitled “Differentially Private Federated Machine Learning for Large Models and a Strong Adversary” filed Oct. 24, 2022. The disclosure of U.S. Provisional Patent Application No. 63/380,743 is hereby incorporated by reference in its entirety for all purposes.

### STATEMENT OF FEDERAL SUPPORT

This invention was made with Government support under Grant No. 2126327 awarded by the National Science Foundation. The Government has certain rights in the invention.

### FIELD OF THE INVENTION

The present invention generally relates to federated machine learning and, more specifically, differentially private federated machine learning for large models.

### BACKGROUND

Machine learning is a branch of artificial intelligence that focuses on using data and algorithms to enable systems to learn from data, identify patterns, and make predictions or decisions without explicit programming. It is a powerful tool that can be used in a wide range of industries and applications today to improve the performance of products and services, automate tasks, and make better decisions. By analyzing large amounts of data, machine learning models can identify patterns and trends that would be difficult or impossible for humans to see. This information can then be used to make more informed decisions in a variety of areas, such as business, healthcare, and finance.

Federated machine learning, the task of training a shared model across parties without revealing private data, is becoming an integral part of modern services and is gaining importance as it allows services to train richer and better-quality models. However, without care, it also risks violating user privacy: a malicious adversary may compromise various elements in a federated learning system such as the aggregator, or perform inference attacks to gain undesired information leakage about individual users' data.

### SUMMARY OF THE INVENTION

Systems and methods for federated learning in accordance with embodiments of the invention are illustrated. One embodiment includes a method for federated learning. The method includes steps for identifying a first set of one or more devices in several devices as members of a master committee, identifying a second set of one or more devices in the several devices as members of a differential privacy (DP)-noise committee, receiving a set of encrypted noise values for differential privacy from the members of the DP-noise committee, receiving, from a third set of one or more devices in the several devices, a set of encrypted update values, and aggregating the encrypted noise values and the encrypted update values to produce encrypted aggregation results. The method further includes steps for receiving, from a fourth set of one or more devices in the several devices, decrypted aggregation results based on decrypted aggregation results based on the encrypted aggregation results and cryptographic key shares of a private cryptographic key from the master committee, and updating model parameters of the model based on the decrypted aggregation results.

In a further embodiment, identifying the first set of devices includes publishing a list of public keys of the members of the master committee to a bulletin board, wherein one or more of the several devices are configured to access the bulletin board to verify the members of the master committee based on the published list of public keys.

In still another embodiment, identifying the first set of devices includes identifying a target size for the master committee, wherein the target size is computed based on a number of committee members required to reconstruct the private cryptographic key.

In a still further embodiment, identifying the second set of devices as members of the DP-noise committee includes identifying a target size for the DP-noise committee, wherein the target size is based on a ratio of known honest devices to total devices.

In yet another embodiment, the set of encrypted noise values from a given member of the DP-noise committee is Gaussian noise data generated independently from any other member of the DP-noise committee.

In a yet further embodiment, the set of encrypted noise values from a given member of the DP-noise committee includes an additive share of a noise budget.

In another additional embodiment, each particular device in the third set of devices randomly selects itself to contribute updates in a given round using a pseudorandom generator seeded with a publicly verifiable random value and a public key of the particular device.

In a further additional embodiment, the method further includes steps for publishing a clipping bound to a bulletin board, wherein the received set of encrypted update values includes are locally generated at each of the third set of devices and are clipped by the clipping bound.

In another embodiment again, the received set of encrypted noise values includes a ciphertext of a plaintext message and the plaintext message includes a round identifier.

In a further embodiment again, the plaintext includes a polynomial with several coefficients.

In still yet another embodiment, the received set of encrypted update values includes a ciphertext of a plaintext message and the plaintext message includes a round identifier.

In still another additional embodiment, the method further includes steps for publishing public keys of at least one of the committee members to a bulletin board.

In a still further additional embodiment, the first set of devices are identified as members of the master committee for a first round. The method further includes identifying a fifth set of one or more devices in the several devices as members of the master committee for a second subsequent round, providing model parameters for the model for a second round to each member of the master committee for the second round, and causing the first set of devices to provide a set of state data to the fifth set of devices, wherein the fifth set of devices uses the set of state data.

In still another embodiment again, the set of state data includes an internal state of a moment accounting process from the first round, wherein the set of state data is signed by more than half of the members of the master committee for the first round.

In a yet further additional embodiment, the encrypted noise values and the encrypted update values includes several ciphertexts, wherein aggregating the encrypted noise values and the encrypted update values includes generating a summation tree for each of the several ciphertexts.

In yet another embodiment again, the method further includes steps for publishing vertices of the summation trees on a bulletin board, wherein at least one device of the third set of devices can verify that update values from the at least one device were included in the model parameter update.

In a yet further embodiment again, each summation tree includes a set of leaf and non-leaf nodes, and each of at least a subset of the several devices verifies the updating of the model parameters by downloading a set of one or more of the summation trees and verifying at least a subset of the set of leaf and non-leaf nodes of each summation tree.

In another additional embodiment again, verifying leaf nodes includes confirming that ciphertexts are committed to and confirming that zero-knowledge (ZK)-proofs are valid.

In a further additional embodiment again, verifying non-leaf nodes includes confirming that the non-leaf node equals a sum of its child nodes.

In still yet another additional embodiment, each child of the non-leaf node is a polynomial, wherein confirming that the non-leaf node equals the sum of its child nodes includes performing polynomial identity testing on the child nodes.

In a further embodiment, the decrypted aggregation results from each of the fourth set of devices includes a smudging error based on distributively sampling a random number.

In still another embodiment, the method is performed for a number of rounds and the private cryptographic key is reused between at least two of the rounds.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a system architecture of an FL system that safeguards differential privacy in participant devices in accordance with an embodiment of the invention.

FIG. 2 illustrates a training process of an FL system in accordance with an embodiment of the invention.

FIG. 3 illustrates a process to add ciphertexts in FL systems in accordance with an embodiment of the invention.

FIG. 4 illustrates a pseudocode of the add phase of FL systems in accordance with an embodiment of the invention.

FIG. 5 illustrates an overview of an implementation of FL systems in accordance with an embodiment of the invention.

FIG. 6 illustrates a network architecture of an FL system in accordance with an embodiment of the invention.

FIG. 7 illustrates an aggregation server that can be utilized to aggregate training data received from participant devices to facilitate decentralized model training in accordance with an embodiment of the invention.

FIG. 8 illustrates a participant device that can be utilized to perform various functions in FL systems in accordance with an embodiment of the invention.

### DETAILED DESCRIPTION

Machine learning is a powerful tool that can be used in a wide range of industries and applications. Machine learning works by using algorithms to learn from data and make predictions. A machine learning algorithm can be trained on a set of training data, which is generally a collection of examples with known inputs and outputs. The training data may be data collected from a number of devices, and the algorithm can learn to identify patterns in the training data and use those patterns to predict the outputs for new inputs. Machine learning allows systems to imitate the way humans learn such that a system can learn and gradually improve from experience. With machine learning, systems can analyze vast amounts of data and make accurate predictions and decisions.

Federated learning (FL) refers to a paradigm in machine learning that utilizes a decentralized training architecture. Unlike the traditional, centralized model of machine learning, where participant devices send their training data to a central server to train a model, FL utilizes a decentralized model of machine learning, where participant devices can download the latest model parameters from the server and perform training locally to generate updates to the model parameters. Participant devices only need to send the generated updates to the server, allowing both the participant devices and the server to reduce network bandwidth usage. The ability to save network bandwidth has allowed FL to become increasingly popular, especially with training models for mobile devices. As FL only requires model updates to be sent to the server, devices in FL enjoy privacy from each other as training data generated locally remains private.

The concept of privacy in a FL system may be less obvious. After all, as participant devices only send updates to model parameters instead of the raw training data, the raw training data (user images, text messages, search queries, etc.) is generally presumed to be private and protected. For a system to provide differential privacy, the system has to be designed such that an adversary cannot deduce raw training data from participant devices by inspecting the updates or the learned model parameters. If the server where the model updates are collected is compromised, the users' raw training data is also at risk of being exposed.

It can be challenging to ensure both the effectiveness of training and the privacy of data between the different client devices at the same time, as current systems for FL exhibit significant trade-offs between model accuracy, privacy, and device efficiency. While some FL systems can provide great accuracy and device efficiency, they can be less proficient in safeguarding privacy. Other systems, such as HybridAlpha and Orchard, offer good accuracy and differential privacy protection of raw training data, but they make assumptions in the FL process that can be exploited and can be very computationally intensive. In fact, Orchard seeks to provide differential privacy under the assumption that the server is byzantine. This means that Orchard actually tries to provide FL while accounting for participant devices that may provide corrupt data and model updates. However, the downside of Orchard is the high overhead for the participant devices. For example, to train a CNN model with 1.2 million parameters, Orchard requires from each device ≈14 minutes of training time on a six-core processor and ≈840 MiB in network transfers per round of training, and the full training may require at least a few hundred rounds. Further, for a few randomly chosen devices, this per-round cost can spike to ≈214 hours of CPU time and ≈11 TiB of network transfers. The high data overhead can make Orchard challenging to use despite it providing differential privacy among the participant devices.

Systems and methods in accordance with many embodiments of the invention can provide FL systems to devices on the scale of billions with reduced device overheads while also protecting differential privacy between the vast number of devices to keep the raw training data of each device confidential. In many embodiments, FL systems provide a federated architecture and training process for efficiently training models over a large number of devices (e.g., hundreds of thousands to several billion) while providing differential privacy, even when a fraction of devices is malicious, and there is no trusted core. FL systems can build upon popular FL algorithms, including but not limited to DP-FedAvg, DP-FedSGD, and DP-FTRL that sample noise from a Gaussian distribution for differential privacy. While current methods such as Orchard run each step of their algorithms among a single committee of devices, systems and methods in accordance with many embodiments are designed to utilize a number of committees of devices where each committee is designed to serve a purpose in the FL algorithm to provide differential privacy to devices participating in FL.

Algorithms such as DP-FedAvg perform FL in discrete rounds. Using DP-FedAvg as an example, in each round t, DP-FedAvg selects a small subset of participant devices using a probability parameter q, and tasks the selected devices with providing updates to the global model parameters. The selected devices locally generate the updates before clipping them by a value S and uploading the updates to a server. DP-FedAvg then aggregates these updates and separately adds noise sampled from a Gaussian distribution. The standard deviation of the Gaussian distribution can depend on a noise scale parameter z and the clipping bound S, where both are input parameters for DP-FedAvg. Finally, DP-FedAvg updates a privacy accountant M that computes, based on the noise scale z and sampling prob-ability q, two parameters ϵ and δ associated with differential privacy. These parameters capture the strength of the FL systems: how much the model parameters learned after a round can vary depending on a device's input. Lower values of δ and ϵ are more desirable, where ϵ should stay close to or below 1, and δ is less than 1/W, where W is the total number of devices.

In some embodiments, FL systems are designed to account for a strong OB+MC threat model. The OB+MC threat model provides that the server receiving model updates is honest but curious most of the time but can be occasionally byzantine (OB). The participant devices are mostly correct (MC), but a small fraction of the devices can be malicious. In this threat model, a malicious server, or even a malicious device, can execute many attacks. For instance, a malicious server can infer the training data of a device from the updates contributed by the device. Similarly, a malicious device that receives model parameters from the server can execute an inference attack to learn another device's input. In numerous embodiments, FL systems can prevent inference attacks where a particular participant device's input is revealed, as models are approximately independent of its input.

### System Architecture

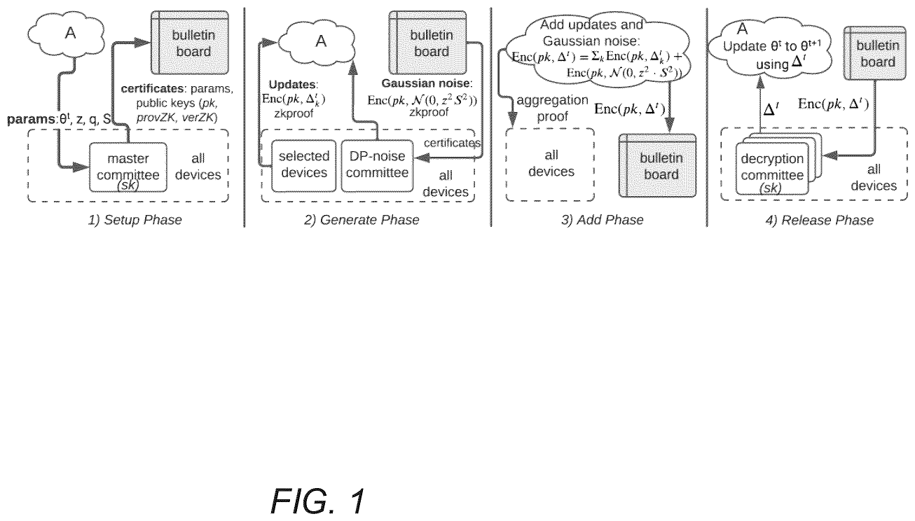

In numerous embodiments of the invention, FL systems are able to create multiple committees, where each committee has a unique function in the FL process for the overall system to provide FL while safeguarding differential privacy. A system architecture of an FL system that safeguards differential privacy in participant devices in accordance with an embodiment of the invention is illustrated in FIG. 1. In many embodiments, FL systems include aggregators and public bulletin boards. Aggregators can combine updates from participant devices without learning the content of the updates. In numerous embodiments, aggregators can be run server-side inside data centers. Bulletin boards may be an immutable append-only log. Even in certain situations where aggregators are potentially malicious under the OB+MC model, aggregators and participant devices can use the bulletin board to reliably broadcast messages and store states of FL systems, including the latest values of differential privacy parameters ϵ and δ across rounds. In many embodiments, FL systems can use free web services such as Wikipedia or a public blockchain as bulletin boards.

In several embodiments, systems are made up of one or more types of committees. An example type of committee is a master committee, which can handle system setup, including key generation for cryptographic primitives. Another example type of committee is a noise committee that can handle Gaussian noise generation. FL systems can use noise committees to provide differential privacy, and noise committees may be denoted as DP-noise committees. A third example type of committee is a decryption committee that can perform decryption operations to release updates to the global model parameters received from the participant devices at the end of a training round. In certain embodiments, FL systems can sample and generate one or more types of committees afresh each round and divide the committee workload across the large population of devices. This feature of using multiple committees to split up the FL workload is crucial for improving efficiency, as it can help tailor a committee's protocol to its tasks more closely to significantly improve efficiency. Further, by generating and using multiple committees of the same type, FL systems can scale with model size as each committee works on a subset of model parameters.

### Federated Learning System Protocol

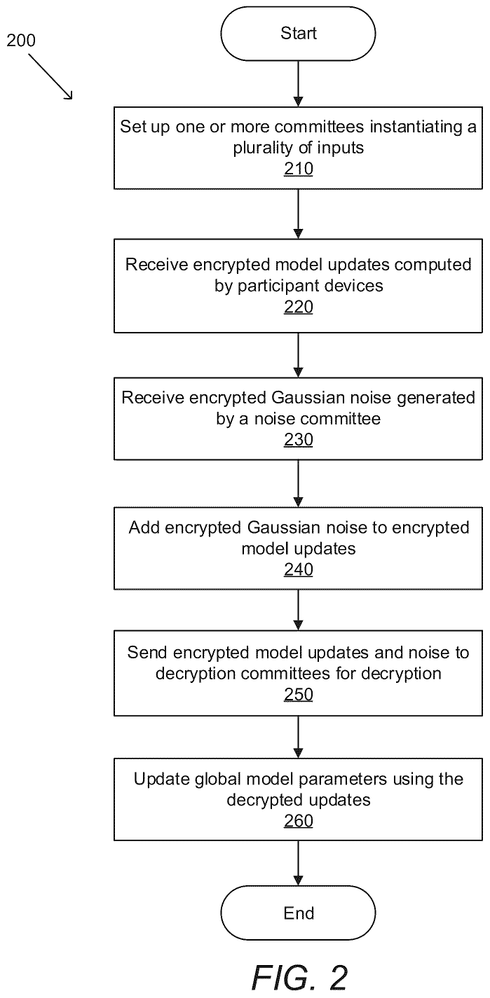

In several embodiments, FL systems receive input parameters at aggregators to begin training a model. Aggregators can then initiate a round-based protocol consisting of discrete rounds. FIG. 2 illustrates a training process of an FL system in accordance with an embodiment of the invention. The training process illustrated in FIG. 2 may be one iteration that is repeated until the training is complete. Process 200 sets (210) up one or more committees instantiating a plurality of inputs. In several embodiments, FL systems can set up each of the one or more committees by choosing a set of one or more devices from all participant devices. Examples of committees include master committees, DP-noise committees, and decryption committees. In many embodiments, aggregators in FL systems can select the devices that can be used to set up committees. In many embodiments, master committees receive and validate the parameters of the plurality of inputs and generate public keys for an additive homomorphic encryption (AHE) and a zero-knowledge proof (ZK-proof) scheme. Unlike other current FL protocols, in several embodiments, FL systems can reuse keys across rounds rather than generating them fresh for each round using multiparty computation (MPC).

Process 200 receives (220) encrypted model updates computed by participant devices. Participant devices can select themselves to generate updates for the round, and updates can be encrypted using the AHE keys. In some embodiments, updates are encrypted gradients of the model being trained.

Process 200 receives (230) Gaussian noise generated by a noise committee. DP-noise committees can generate the Gaussian noise for DP. In selected embodiments, DP-noise committees generate noise in a distributed manner while avoiding using MPC. Generated Gaussian noise can also be encrypted using the public AHE keys.

Process 200 adds (240) encrypted Gaussian noise to encrypted model updates. Due to the nature of AHE, model updates and Gaussian noise can be manipulated and added despite being encrypted ciphertexts. In certain embodiments, aggregators add the model updates to the Gaussian noise without learning the plaintext content of either of them due to the AHE scheme in place. The entire population of participant devices can collectively verify the aggregator's work using a new verifiable aggregation protocol, which will be further discussed below.

Process 200 sends (250) encrypted model updates and noise to decryption committees for decryption. Decryption committees can receive the key for the AHE scheme from master committees and decrypt the ciphertexts from the add phase. Process 200 updates (260) global model parameters using the decrypted updates.

While specific processes for training models in FL systems are described above, any of a variety of processes can be utilized to train models as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

In many embodiments, FL systems perform each round of training where it undergoes a four-phase process of setup, generate, add, and release. Each phase of the process can keep the device overhead low while protecting against the malicious aggregator and the malicious subset of devices. The verifiable aggregation in the add phase can protect model updates, and key resharing and fast decryption protocols can keep secret keys hidden.

In several embodiments, before the setup phase takes place, FL systems begin with committee formation. In numerous embodiments, FL systems utilize sortition protocols that are based on Algorand's protocol to select devices to form committees. In selected embodiments, sortition protocols rely on a publicly verifiable source of randomness so that the results of the selection are verifiable by all devices. At the end of the sortition protocol, aggregators can publish the list of the committee members and public keys on the bulletin board. An important aspect of committee formation is the committee size and the number of potentially malicious devices in a committee. The provision of a larger number of malicious devices A relative to the committee size C can increase costs but can also increase resiliency. In many embodiments, FL systems make a probabilistic argument to select C and A such that the probability of the number of malicious devices exceeding A is small. For example, if the overall population contains up to f=3% malicious devices, then the probability that a randomly sampled subset of C=45 devices contains more than

$$A = \frac{2 C}{5} = 18$$

malicious devices is less than 9.6·10⁻¹⁴.

In the setup phase, aggregators can select devices for the master committee and receive inputs for the round. Inputs may be model parameters θ^{t} for the current round t, the device selection probability q, noise scale z, and clipping bound S. Clipping can bound the model updates such that no one participant device can overly influence the training. Additionally, in numerous embodiments, the amount of noise used to protect the model updates is based on the model updates. By clipping the model updates, malicious devices in the DP-noise committee are unable to generate too much or too little noise. Clipping can help with providing differential privacy, and it bounds the norm (sensitivity) of a device's generated update. In several embodiments, aggregators can validate the inputs and generate new values of the DP parameters ϵ, δ based on the inputs. Aggregators can generate keys for cryptographic primitives, including AHE and ZK-proof. In selected embodiments, generated keys can be reused across rounds of the FL process. Instead of generating the keys afresh for each round, reusing keys allows FL systems to greatly reduce overheads. Master committees in the first round of the FL process can generate the keys and share them with selected committees for the next round, and these committees can then share the keys with the next selected committee for the third round, and so on.

While it may be possible for the key-reusing scheme to be attacked by malicious aggregators, FL systems in many embodiments can adjust the generate and add phases to defend from attacks. For example, if the malicious aggregator receives a victim device k's update Enc(pk, Δₖ^{t}) in round t. Then, in the next round t+1, the aggregator can collude with a malicious device in the overall population to use Enc(pk, Δₖ^{t}) as the device's update. This attack enables the aggregator to violate differential privacy as the victim device's input does not satisfy the required clipping bound S in round t+1 due to its multiple copies.

In several embodiments, FL systems can implement an efficient verifiable secret redistribution scheme such that committee members at round t+1 securely obtain the relevant shares of the AHE secret key sk from the committee at round t. For the public keys (AHE public key pk, and both the ZK-proof public proving and verification keys), committees for round t can sign a certificate containing these keys and upload it to the bulletin board, and the committee for round t+1 can download it from the board. The savings in overhead by switching from key generation for each round to key sharing across different rounds are substantial for the network. While the MPC solution used in current FL systems incurs approximately 1 GiB of network transfers and 180 seconds of CPU time per committee device, the key-sharing method, as discussed above, only requires 125 MiB of network transfers and 187 seconds of CPU time, respectively.

In numerous embodiments, FL systems select a subset of participant devices in the generate phase to generate updates to the model parameters. In some embodiments, FL systems select a subset of participant devices using the sortition protocol discussed above to form DP-noise committees that can generate Gaussian noise for differential privacy. In many embodiments, devices from both committees encrypt their generated data.

In several embodiments, FL systems task aggregators to select devices to contribute to providing model updates. Aggregators in FL systems should remain fair in their selection of participant devices. For example, aggregators should not pick an honest device more often than the device should be picked, hence violating differential privacy. If the selection of devices is made by tasking the devices themselves to perform the sampling, a malicious may pick itself in every round, allowing it to significantly affect model accuracy.

In many embodiments, FL systems adopt a hybrid and efficient design in which devices select themselves but have the aggregators verify the selections. Let B^{t} be a publicly verifiable source of randomness for round t where B^{t} is the same randomness that is used in the sortition protocol to select committees for the round. Each device k with public key πₖ can compute PRG(πₖ∥B^{t}), where PRG is a pseudorandom generator. Each device can scale the PRG output to a value between 0 and 1 and check if the result is less than q. For instance, if the PRG output is 8 bytes, then the device divides this number by 2⁶⁴-1. If selected, the device can generate updates for the round. This approach of sampling can be efficient as devices only perform local computations.

In several embodiments, FL systems utilize distributed Gaussian noise generation to mask the model updates. The Gaussian distribution has the property that if an element sampled from [symbol] (0, a) is added to another element sampled from [symbol] (0, b), then the sum is a sample of [symbol] (a+b). This works well for the simple case when all C committee members of the DP-noise committee are honest. Given the standard deviation of the Gaussian distribution, σ=z·S, the devices can independently compute their additive shares of noise to be generated. That is, to generate samples from [symbol] (0, Iσ²), each committee member can sample its share of the noise from the distribution [symbol] (0, Iσ²).

It is possible that there may be a number of malicious devices in the DP-noise committee, and therefore, it is important for FL systems to be able to account for these malicious devices. Malicious devices may behave arbitrarily and can thus generate either no noise or large amounts of it, which, in turn, can hinder the FL process. While adding more noise than necessary does not hurt privacy, adding more noise may hurt the accuracy of training. On the other hand, failing to add noise may affect privacy. In the worst-case scenario in which malicious devices fail to add any noise and ask honest devices to compensate, each honest client can sample its noise share from the distribution

$$𝒩 ( 0 , I \frac{{σ}^{2}}{C - A} ) .$$

This algorithm can generate noise at less cost without the expensive MPC. While it may generate more noise than necessary, which can hurt accuracy, in many embodiments, FL systems can choose the committee size such that there is a high probability bound on the number of malicious devices to minimize the ratio of additional noise. Specifically, C can be chosen to keep the ratio

$$𝒩 ( 0 , I \frac{{σ}^{2}}{C - A} ) .$$

close to 1.

Once the devices generate their updates or shares of the Gaussian noise, they can encrypt the content using the public key of the AHE scheme to prevent the aggregator from learning the content. Further, devices that generated the updates can certify using a ZK-proof scheme that the encryption is done correctly and the data being encrypted is bounded by the clipping value S so that malicious devices may not supply arbitrary updates. Each device can concatenate the round number t, which is used as a timestamp, to the plaintext model update message before encrypting it. Further, the ZK-proof can include additional constraints that prove that a prefix of the plaintext message equals the current round number. In several embodiments, this encryption scheme provides that the ciphertext generated in a round is used only in that round to prevent complications due to the reuse of keys.

In numerous embodiments, aggregators of FL systems add ciphertexts containing model updates to ciphertexts containing shares of generated noise in the add phase of the FL process. The devices can collectively verify that the aggregators have performed the additions correctly.

The add phase of the FL process has two requirements. Consider an example with two honest devices and a malicious device, where the first honest device's input is Enc(pk, [symbol] ), where [symbol] is its model update, while the second honest device's input is Enc(pk, n), where n is the Gaussian noise. Aggregators shall not omit Enc(pk, n) from the aggregate, as the added noise would then be insufficient to protect Δ and provide DP. Aggregators shall not let the malicious device use Enc(pk, Δ) as its input. Relatedly, aggregators shall not modify Enc(pk, Δ) to Enc(pk, k·Δ), where k is a scalar, using the additively homomorphic properties of the encryption scheme. These changes can violate the clipping requirement that a device's input is bounded by S. Aggregators shall also satisfy the above requirement across the various rounds of the FL process since the same encryption key can be used in multiple rounds.

In several embodiments, these requirements can be satisfied by the use of a verifiable aggregation protocol based on summation trees. Aggregators can arrange the ciphertexts to be aggregated as leaf nodes of a tree and publish the nodes of the tree leading to the root node. In the context of the example above, the leaf nodes of the summation tree would be Enc(pk, Δ) and Enc(pk, n) , and the root nodes of the summation tree would be Enc(pk, Δ)+Enc(pk, n). Devices in the entire population may inspect parts of the summation tree by downloading a few child nodes and their parent nodes and checking whether the addition is done correctly. Devices can also check that the leaf nodes have not been modified by the aggregator and that the leaf nodes that should be included are indeed included. In many embodiments, instead of using a large overall summation tree that results in massive aggregated nodes, FL systems utilize l summation trees where l is the number of ciphertexts comprising a device's update. Nodes on each of the l summation trees can be kept smaller to reduce computational load. Each device that verifies the aggregation results can probabilistically select a handful of trees and check a few nodes within each selected tree.

Additionally, FL systems can optimize how devices test whether the sum of two ciphertexts equals a third ciphertext. Ciphertexts can be expressed as polynomials, and the validity of their addition can be checked efficiently using a technique called polynomial identity testing (PIT). PIT provides that the sum of polynomials can be checked by evaluating them at a random point and checking the sum of these evaluations. Using PIT, in many embodiments, FL systems can replace the ciphertexts at the non-leaf nodes of the summation trees with their much smaller evaluations at a random point.

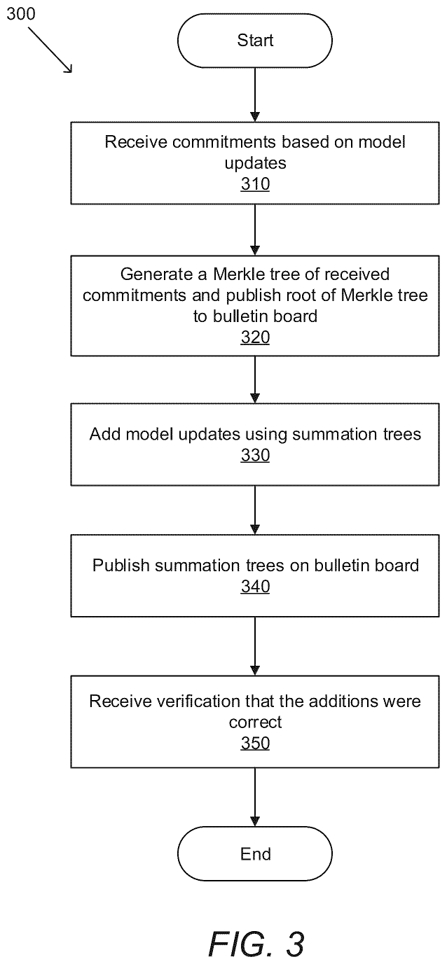

FIG. 3 illustrates a process to add ciphertexts in FL systems in accordance with an embodiment of the invention. Process 300 receives (310) commitments based on model updates. In numerous embodiments, all devices responsible for generating model updates commit to the ciphertexts corresponding to their updates before submitting them to the aggregator.

Process 300 generates (320) a Merkle tree of the received commitments and publishes the root of the Merkle tree to the bulletin board. In many embodiments, step 320 is performed by aggregators. Committing to the ciphertexts before submitting can reduce the possibility of a malicious device copying and submitting an honest device's input. This design can also make it so that aggregators cannot change a device's input.

Process 300 adds (330) model updates using summation trees. In many embodiments, aggregators in FL systems add the ciphertexts via summation trees. Specifically, if device updates have l ciphertexts, aggregators can create l summation trees where one tree is created per ciphertext. Leaf vertices of the j-th tree are the j-th ciphertexts in the devices' inputs, while each parent is the sum of its children ciphertexts, and the root is the j-th ciphertext in the aggregation result.

Process 300 publishes (340) the summation trees on the bulletin board. Aggregators can publish the vertices of the summation trees on the bulletin board, allowing an honest device to check that its input is not omitted.

Process 300 receives (350) verification that the additions were correct. In many embodiments, each device in the system selects q·l summation trees, where q is the device sampling probability, and checks s leaf nodes and 2s non-leaf nodes in each tree. Specifically, each device can check that the leaf node ciphertexts are committed to in the commit step by referring back to the published Merkle tree and the ZK-proofs of the ciphertexts are valid. In other words, each device may check that the first part of the plaintext message in the ciphertexts equals the current round number. For the non-leaves, devices may check that they sum to their children. In several embodiments, each device sends a confirmation to aggregators after verification is complete.

While specific processes for adding ciphertexts in FL systems are described above, any of a variety of processes can be utilized to add ciphertexts as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

Checking the non-leaf vertices can be a source of large overhead. Even with the use of multiple summation trees, ciphertexts may nonetheless be large. In many embodiments, FL systems can reduce this overhead by utilizing PIT. Given a d-degree polynomial g(x) whose coefficients are in a field [symbol] g(x) can be tested by picking a number r ∈ [symbol] uniformly and testing whether g(r)==0 to determine whether g(x) is a zero polynomial. In some embodiments, FL systems can replace the ciphertexts at the non-leaves with their evaluations at a random point r using PIT. During verification, a device can check whether the evaluations are added correctly. Thus, instead of downloading three ciphertexts with 2·2¹² field elements each, a device may download just two elements of [symbol] per ciphertext. A requirement for PIT is the generation of r, which needs to be sampled uniformly from the coefficient field. In selected embodiments, FL systems can request the master committee to publish an r to the bulletin board in the add step to securely and efficiently generate a random number.

In many embodiments, FL systems release the model updates to update the model. FL systems can decrypt the l ciphertexts from the add phase. In several embodiments, FL systems set up multiple decryption committees. To reduce per-device work, each committee decrypts a few of the l ciphertexts. While more decryption committees can increase decryption speed, they can also lead to larger overhead. More decryption committees also mean that each committee has to be larger such that none of the committees select more than A out of C malicious devices, thus breaking the threshold assumptions of a committee.

In numerous embodiments, FL systems use a fast-distributed decryption protocol to decrypt the ciphertexts. The use of this protocol is possible as a decryption committee's only task is decryption, given how different types of committees were formed. In many embodiments, committee devices perform local computations with little interaction with each other. Committee members need to know an upper bound on the number of additive homomorphic operations on the ciphertexts they are decrypting. In many embodiments, the upper bound is the maximum number of devices whose data the aggregator adds in the add phase. The benefit of distributed decryption without the use of MPC is substantial. The network cost of decrypting ten ciphertexts can be reduced from ≈380 GiB to ≈5 MiB.

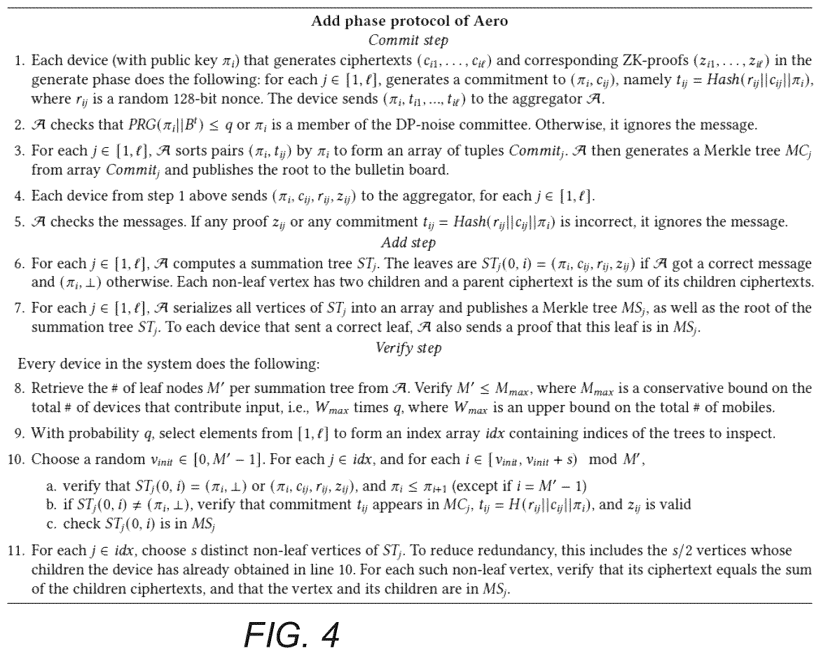

FIG. 4 illustrates a pseudocode of the add phase of FL systems in accordance with an embodiment of the invention. In several embodiments, FIG. 4 outlines the commit-add-verify protocol discussed above.

### Software Implementation

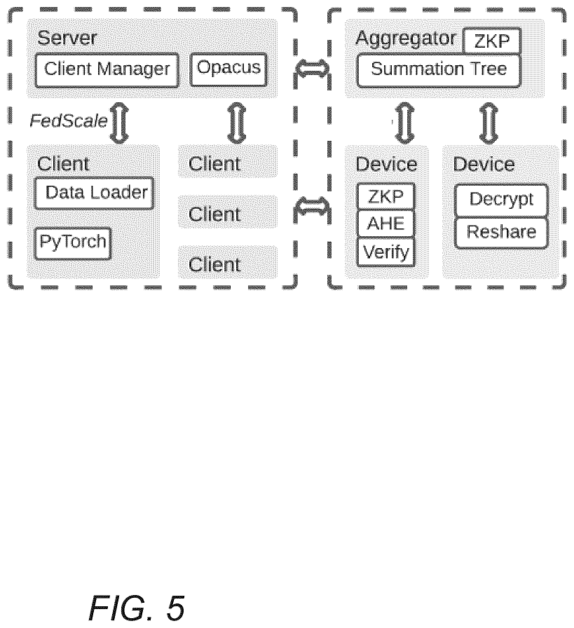

In many embodiments, FL systems are implemented as an extension of FedScale, which is a scalable system for federated learning capable of handling a large number of devices. FIG. 5 illustrates an implementation of FL systems in accordance with an embodiment of the invention. In many embodiments, FL systems can be implemented on top of an FL algorithm. FL algorithms may be implemented in a server. In some embodiments, the FL algorithm may be FedScale. By default, FedScale can support algorithms such as FedAvg and FedSGD (without differential privacy). In several embodiments, frameworks are used to allow for specific selections of the models to be used in FL. In certain embodiments, a PyTorch framework can be used to choose models used in FedScale.

In several embodiments, FL systems utilize the programming layer of FedScale with a library that can adjust models to make them suitable for differentially private FL. In some embodiments, the library is Opacus, which can adjust PyTorch models to make them suitable for differentially private federated learning. For example, Opacus can replace the batch normalization layer of a neural network with group normalization. In some embodiments, FL systems extend the device-side code of FedScale with additional components needed to form various committees and perform phases of the protocol. FL systems can form master committees that provide AHE and ZK-proof encryption. FL systems can form decryption committees that decrypt and release model updates. Additionally, FL systems can form noise committees to generate noise and provide differential privacy. In selected embodiments, FL systems configure the cryptographic primitives for 128-bit security. For additively homomorphic encryption, the BFV encryption scheme can be used. In certain embodiments, the polynomial degree in BFV was set to 212. ark_groth16, which implements the zkSNARK of Jens Groth, can be used to generate ZK-proofs.

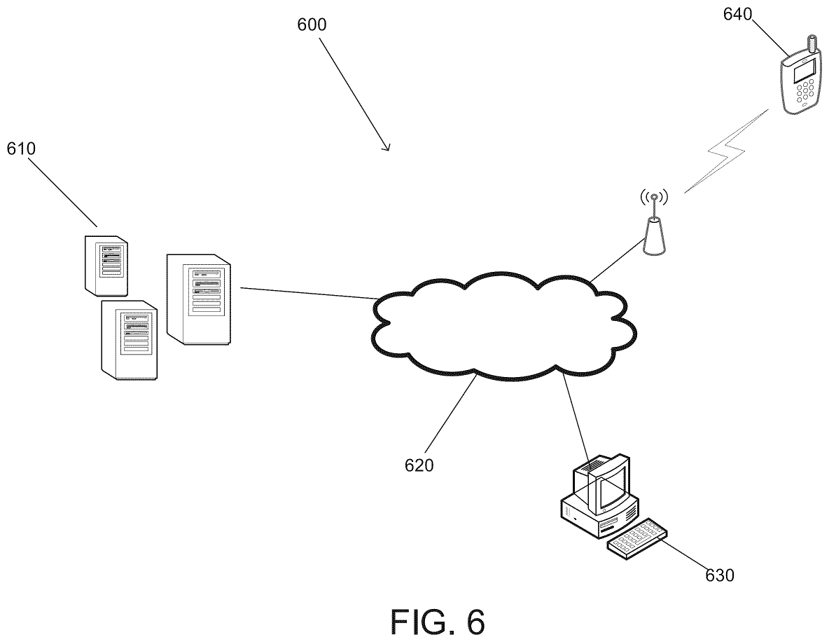

FIG. 6 illustrates a network architecture of an FL system in accordance with an embodiment of the invention. Such embodiments may be utilized to facilitate private and federated learning in many devices, and a central computing device such as a server or a data center performs one or more features, functions, methods, and/or steps described herein. In such embodiments, a computing device 610 (e.g., server) is connected to a network 620 (wired and/or wireless), where it can receive inputs from one or more computing devices. Computing device 610 may be an aggregation server implemented in a data center capable of handling the network traffic and computational load of training data from many devices.

System 600 may also include computing devices 630 and 640. Computing devices 630 and 640 may be the participant devices performing private and decentralized training. Processes that provide the methods and systems for FL in accordance with some embodiments are executed by a computing device or computing system, such as a desktop computer, tablet, mobile device, laptop computer, notebook computer, server system, and/or any other device capable of performing one or more features, functions, methods, and/or steps as described herein. Computing device 640 may be a remote computing device connected to network 620 using a wireless cellular connection. Once computing devices 630 and 640 perform one or more features, functions, methods, and/or steps described herein, any outputs can be transmitted to computing device 610 for performing one or more features, functions, methods, and/or steps described herein.

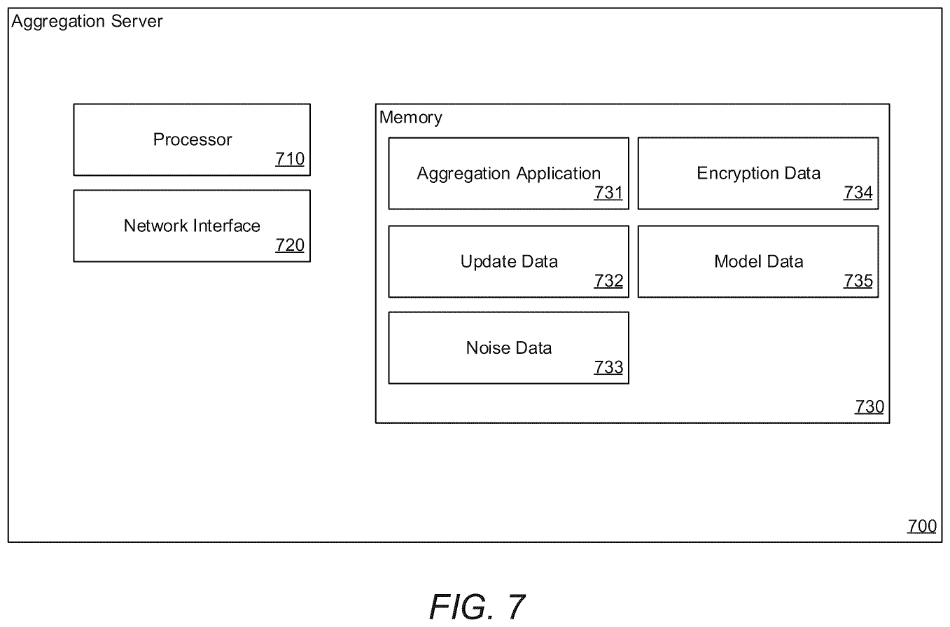

FIG. 7 illustrates an aggregation server that can be utilized to aggregate training data received from participant devices to facilitate decentralized model training in accordance with an embodiment of the invention. Aggregation server 700 includes a processor 710. Processor 710 may direct the aggregation application 731 to aggregate received training data based on a combination of update data 732, noise data 733, encryption data 734, and model data 735. In many embodiments, processor 710 can include a processor, a microprocessor, a controller, or a combination of processors, microprocessor, and/or controllers that performs instructions stored in a memory 730 to perform FL. Processor instructions can configure the processor 710 to perform processes in accordance with certain embodiments of the invention. In various embodiments, processor instructions can be stored on a non-transitory machine readable medium. Aggregation server 700 further includes a network interface 720 that can receive update data, noise data, encryption data, and model data from external sources. Aggregation server 700 may further include a memory 730 to store update data 732, noise data 733, encryption data 734, and model data 735.

Although a specific example of an aggregation server is illustrated in this figure, any of a variety of aggregation servers can be utilized to aggregate training data in federated learning similar to those described herein as appropriate to the requirements of specific applications in accordance with embodiments of the invention.

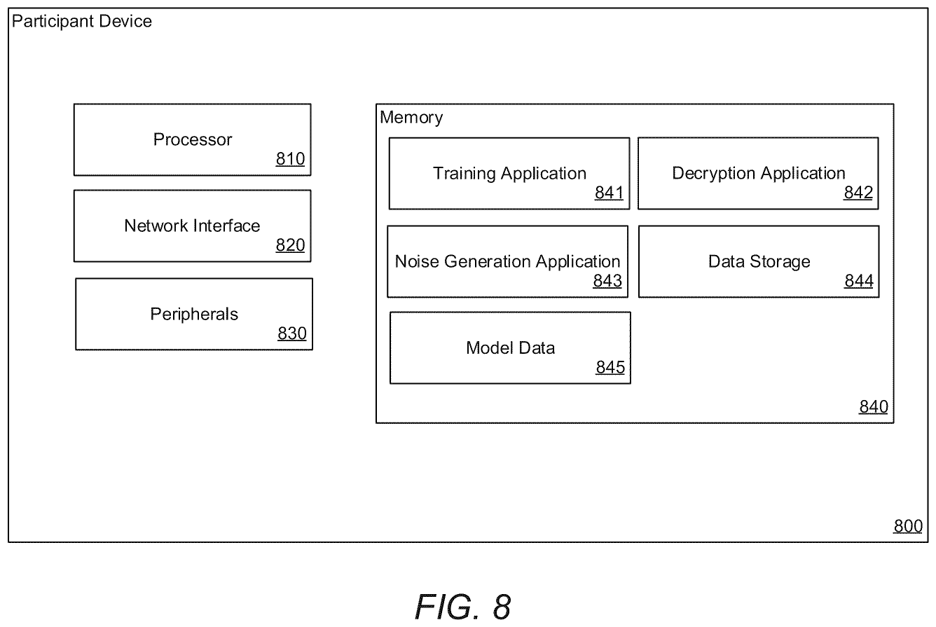

FIG. 8 illustrates a participant device that can be utilized to perform various functions in FL systems in accordance with an embodiment of the invention. Participant device 800 includes a processor 810. Processor 810 may direct training application 841 to generate model updates that can be used to train models. Participant devices that include training applications may be devices that can be selected to generate model updates. In some embodiment, participant devices may include decryption application 842 instead of training application 841. Participant devices that include decryption applications may be member devices of decryption committees. Processor 810 may direct decryption application 842 to decrypt model updates after aggregation. In some embodiments, participant device 800 may include noise generation application 843 instead of training application 841 or decryption application 842. Participant device 800 that includes noise generation applications may be member devices of DP-noise committees. Processor 810 may direct noise generation application 843 to generate noise to protect the privacy of model updates. Training application 841, decryption application 842, and noise generation application 843 can be stored in memory 840. Various types of data that may be generated by applications can be stored in data storage 844. Memory 840 may optionally include model data 845 for applications that interface with models for training purposes.

In many embodiments, processor 810 can include a processor, a microprocessor, a controller, or a combination of processors, microprocessor, and/or controllers that performs instructions stored in a memory 840 to perform FL. Processor instructions can configure the processor 810 to perform processes in accordance with certain embodiments of the invention. In various embodiments, processor instructions can be stored on a non-transitory machine readable medium.

Participant device 800 further includes network interface 820 that can receive various types of data from external sources. Participant devices may further include peripheral 830. Peripherals 830 can include any of a variety of components for capturing data, such as (but not limited to) mice, keyboards, and/or sensors. In a variety of embodiments, peripherals can be used to gather inputs and/or provide outputs.

Although a specific example of a participant device is illustrated in this figure, any of a variety of participant devices can be utilized in federated learning similar to those described herein as appropriate to the requirements of specific applications in accordance with embodiments of the invention.

In accordance with still other embodiments, the instructions for the processes can be stored in any of a variety of non-transitory computer readable media appropriate to a specific application.

Although specific methods of learning in a federated and DP manner are discussed above, many different methods of learning in a federated and DP manner can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for federated learning, the method comprising:
identifying a first set of one or more devices in a plurality of devices as members of a master committee;
identifying a second set of one or more devices in the plurality of devices as members of a differential privacy (DP)-noise committee;
receiving a set of encrypted noise values for differential privacy from the members of the DP-noise committee;
receiving, from a third set of one or more devices in the plurality of devices, a set of encrypted update values;
aggregating the encrypted noise values and the encrypted update values to produce encrypted aggregation results;
receiving, from a fourth set of one or more devices in the plurality of devices, decrypted aggregation results based on the encrypted aggregation results and cryptographic key shares of a private cryptographic key from the master committee; and
updating model parameters of the model based on the decrypted aggregation results.

2. The method of claim 1, wherein identifying the first set of devices comprises publishing a list of public keys of the members of the master committee to a bulletin board, wherein one or more of the plurality of devices are configured to access the bulletin board to verify the members of the master committee based on the published list of public keys.

3. The method of claim 2, wherein the bulletin board is a blockchain.

4. The method of claim 1, wherein identifying the first set of devices comprises identifying a target size for the master committee, wherein the target size is computed based on a number of committee members required to reconstruct the private cryptographic key.

5. The method of claim 1, wherein identifying the second set of devices as members of the DP-noise committee comprises identifying a target size for the DP-noise committee, wherein the target size is based on a ratio of known honest devices to total devices.

6. The method of claim 1, wherein the set of encrypted noise values from a given member of the DP-noise committee are Gaussian noise data generated independently from any other member of the DP-noise committee.

7. The method of claim 1, wherein the set of encrypted noise values from a given member of the DP-noise committee comprise an additive share of a noise budget.

8. The method of claim 1, wherein each particular device in the third set of devices randomly selects itself to contribute updates in a given round using a pseudorandom generator seeded with a publicly verifiable random value and a public key of the particular device.

9. The method of claim 1 further comprising publishing a clipping bound to a bulletin board, wherein the received set of encrypted update values comprises are locally generated at each of the third set of devices and are clipped by the clipping bound.

10. The method of claim 1, wherein the received set of encrypted noise values includes a ciphertext of a plaintext message and the plaintext message comprises a round identifier.

11. The method of claim 1, wherein the received set of encrypted update values includes a ciphertext of a plaintext message and the plaintext message comprises a round identifier.

12. The method of claim 1 further comprising publishing public keys of at least one of the committee members to a bulletin board.

13. The method of claim 1, wherein:
the first set of devices are identified as members of the master committee for a first round; and
the method further comprises:
identifying a fifth set of one or more devices in the plurality of devices as members of the master committee for a second subsequent round;
providing model parameters for the model for a second round to each member of the master committee for the second round; and
causing the first set of devices to provide a set of state data to the fifth set of devices, wherein the fifth set of devices uses the set of state data.

14. The method of claim 1, wherein the encrypted noise values and the encrypted update values comprise a plurality of ciphertexts, wherein aggregating the encrypted noise values and the encrypted update values comprises generating a summation tree for each of the plurality of ciphertexts.

15. The method of claim 14 further comprising publishing vertices of the summation trees on a bulletin board, wherein at least one device of the third set of devices can verify that update values from the at least one device were included in the model parameter update.

16. The method of claim 15, wherein:
each summation tree comprises a set of leaf and non-leaf nodes; and
each of at least a subset of the plurality of devices verifies the updating of the model parameters by downloading a set of one or more of the summation trees and verifying at least a subset of the set of leaf and non-leaf nodes of each summation tree.

17. The method of claim 16, wherein verifying leaf nodes comprises confirming that ciphertexts are committed to and confirming that zero-knowledge (ZK)-proofs are valid.

18. The method of claim 16, wherein verifying non-leaf nodes comprises confirming that the non-leaf node equals a sum of its child nodes.

19. The method of claim 18, wherein each child of the non-leaf node is a polynomial, wherein confirming that the non-leaf node equals the sum of its child nodes comprises performing polynomial identity testing on the child nodes.

20. A non-transitory machine readable medium containing program instructions that are executable by a set of one or more processors to perform the method of claim 1.
